(19) United States
(12) Patent Application Publication
(10) Pub. No.: US 2022/0254041 A1
(43) Pub. Date: Aug. 11, 2022

(54) IMAGE PROCESSING DEVICE, STORAGE MEDIUM, AND IMAGE PROCESSING METHOD

(71) Applicant: CANON KABUSHIKI KAISHA, Tokyo (JP)

(72) Inventors: Naoki Tsukabe, Kanagawa (JP); Kazuki Udono, Kanagawa (JP); Genki Cho, Kanagawa (JP)

(21) Appl. No.: 17/589,010

(22) Filed: Jan. 31, 2022

(30) Foreign Application Priority Data
Feb. 8, 2021 (JP) 2021-018241

(51) Int. Cl. G06T 7/33; G06T 1/00

(52) U.S. Cl. CPC G06T 7/344; G06T 2207/20081; G06T 1/0007; G06T 7/337

(57) ABSTRACT

To provide an image processing device capable of obtaining support information for optimizing a matching model when the matching model is generated, the image processing device includes: an image acquisition unit; a matching model acquisition unit configured to acquire an image processing matching model based on an image acquired by the image acquisition unit; an image transformation unit configured to perform predetermined transformation on the image to acquire a transformed image; a comparison unit configured to compare the matching model acquired by the matching model acquisition unit with the transformed image acquired by the image transformation unit; and a display unit configured to display support information for optimizing the matching model based on a result of the comparison unit.

### BACKGROUND OF THE INVENTION

### Field of the Invention

The present invention relates to an image processing device, a storage medium, and an image processing method using a matching model.

### Description of the Related Art

When production, quality verification, transportation, and the like of products in manufacturing sites are performed, many imaging devices and image processing devices are used to verify states of measurement targets (hereinafter referred to as works). For example, when measurement of positions and postures of works is desired to be performed, matching models are generated from images of the works acquired in advance. By performing pattern matching on captured images, similar regions in the captured images are identified and the positions and postures of the works are estimated.

When pattern matching is performed, it is necessary to determine various parameters related to model generation and generate matching models by performing imaging for the model generation in advance. However, in an environment in which there is a disturbance, it is difficult to generate matching models capable of performing matching stably and accurately and it takes much time to generate images for model generation while selecting the images based on experience of skilled workers. Therefore, as a technology for acquiring images for more appropriate matching model generation, Japanese Patent Laid-Open No. 2010-205007 discloses a technology for selecting optimum images among a plurality of image candidates for model generation.

Japanese Patent Laid-Open No. 2015-007972 discloses a technology for performing robust matching by applying different changes to images for model generation to generate a plurality of change images and generating a matching model based on feature amounts extracted from the change images.

In the technologies disclosed in Japanese Patent Laid-Open No. 2010-205007 and Japanese Patent Laid-Open No. 2015-007972, models less likely to have an influence that changes generation of a model are generated, but optimum matching models desired by users may not be generated. It cannot be checked whether a completed matching model has features desired by a user. Therefore, it is necessary to repeat model generation and site tests to obtain matching models optimum for users.

An objective of the present invention is to provide an image processing device capable of obtaining support information for optimizing a matching model when the matching model is generated.

### SUMMARY OF THE INVENTION

To achieve the foregoing objective, an image processing device according to an aspect of the present invention includes at least one processor and/or circuit configured to function as: an image acquisition unit; a matching model acquisition unit configured to acquire an image processing matching model based on an image acquired by the image acquisition unit; an image transformation unit configured to perform predetermined transformation on the image to acquire a transformed image; a comparison unit configured to compare the matching model acquired by the matching model acquisition unit with the transformed image acquired by the image transformation unit; and a display unit configured to display support information for optimizing the matching model based on a result of the comparison unit.

Further features of the present invention will become apparent from the following description of embodiments with reference to the attached drawings.

### BRIEF DESCRIPTION OF THE DRAWINGS

FIG. 1 is a diagram illustrating an overview of a manufacturing system according to a first embodiment.

FIG. 2 is a block diagram illustrating a hardware configuration of an imaging processing device 101 and an imaging device 102 according to the first embodiment.

FIG. 3 is a flowchart illustrating an operation of the image processing device 101 when a matching model is generated according to the first embodiment.

FIG. 4 is a diagram illustrating a method of estimating a change in similarity related to a change in rotation according to the first embodiment.

FIG. 5 is a diagram illustrating a change in the similarity related to the change in rotation when model generation parameters are different according to the first embodiment.

FIG. 6 is a diagram illustrating a GUI on which model features are displayed according to the first embodiment.

FIG. 7A is a diagram illustrating a method of displaying model features related to a change in tilt and brightness according to the first embodiment and FIG. 7B is a diagram illustrating examples of a plurality of transformed images when a change in brightness is performed.

FIG. 8A is a diagram illustrating an example of a GUI when regeneration is supported according to the first embodiment, FIG. 8B is a diagram illustrating a recommended model 803 or a recommended model generation region 804, and FIG. 8C is a diagram illustrating an example in which a primary searching matching model 805 and a secondary searching matching model 806 for angle determination are individually displayed.

FIG. 9 is a diagram illustrating an overview of a manufacturing system according to a second embodiment.

FIG. 10A is a flowchart related to model generation according to the second embodiment and FIG. 10B is a flowchart for determining model generation parameters.

FIG. 11 is a diagram illustrating an example of a list of stored model generation parameters according to the second embodiment.

FIG. 12 is a diagram illustrating an example of searching of a similar region by matching according to the second embodiment.

FIG. 13 is a diagram illustrating a result of the searching illustrated in FIG. 12.

FIG. 14 is a diagram illustrating an example of transformation of a region based on detection information according to the second embodiment.

FIG. 15 is a diagram illustrating an example of a GUI for setting a contrast threshold.

### DESCRIPTION OF THE EMBODIMENTS

Hereinafter, with reference to the accompanying drawings, a favorable mode of the present invention will be described using embodiments. In each diagram, the same reference signs are applied to the same members or elements, and duplicate description will be omitted or simplified.

In the embodiments, devices such as an imaging device and an image processing device which are separate will be exemplified in description, but constituent elements described in the embodiments are merely exemplary and the present invention is not limited to the embodiments.

### First Embodiment

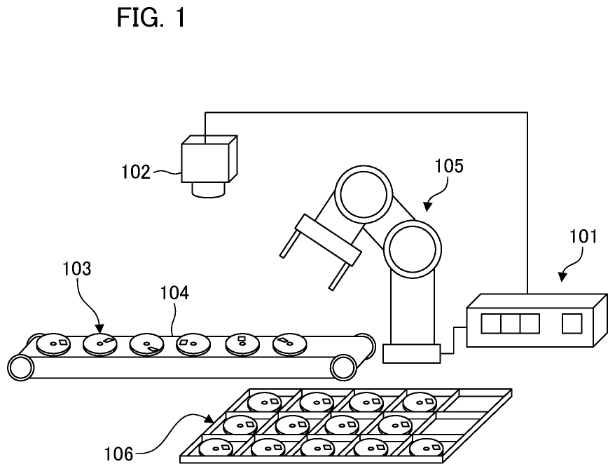

Hereinafter, a first embodiment of the present invention will be described with reference to FIGS. 1 to 8.

FIG. 1 is a diagram illustrating an overview of a manufacturing system according to the first embodiment. The manufacturing system will be described with reference to FIG. 1.

The manufacturing system according to the first embodiment includes an image processing system that includes an image processing device 101 and an imaging device 102 to align rotational angles (postures) of works 103 in a pallet 106 using a robot 105. The image processing device 101 acquires images of the works 103 supplied to a conveyance stand 104 at random positions and postures using the imaging device 102, calculates the positions and postures of the works 103, and transmits measurement results to the robot 105.

The image processing device 101 is, for example, a general personal computer and implements an image processing function by executing software which is a computer program stored in a memory. The image processing device 101 is connected to the imaging device 102, and can acquire images captured by the imaging device 102 at any timing and perform various kinds of image processing. The imaging device 102 is installed at a position at which the works 103 on the conveyance stand 104 present within a movable range of the robot 105 can be imaged. The works 103 have, for example, an optical surface for identifying a rotational angle (posture).

The image processing device 101 has a model generation function and a pattern matching function as image processing functions. That is, by generating and registering a model from the images of the works 103 in advance, it is possible to perform pattern matching on the images of the works 103 acquired from the imaging device 102 and estimate positions and postures of the works 103 in the images.

The image processing device 101 is connected to the robot 105, and acquires an image from the imaging device 102 in response to a request from the robot 105 and transmits a position and posture of the works in the acquired image to the robot 105. The robot 105 can acquire the position and posture of the works 103 by transmitting a request to the image processing device 101. The robot 105 includes a known transformation unit that transforms a position and posture on an image and a position and posture on robot coordinates and can grasp the works 103 on the conveyance stand 104 at any posture based on the position and posture of the works 103 acquired from the image processing device 101.

Thus, the works 103 are carried and disposed while correction is performed so that the works 103 are aligned in the same rotational direction on the pallet 106.

The transformation unit may be provided in an external device or the like other than the robot 105 and may control the robot 105 based on a result obtained by allowing the external device to perform the transformation.

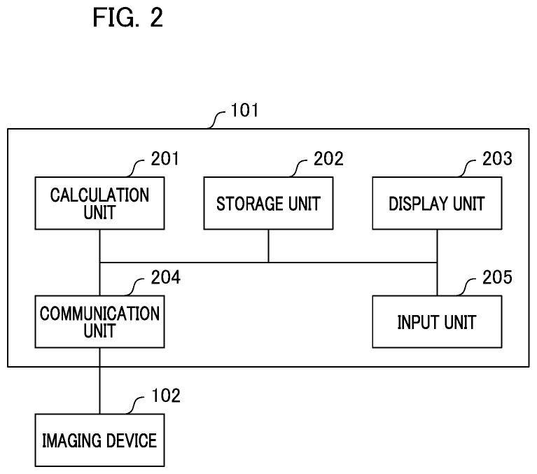

FIG. 2 is a block diagram illustrating a hardware configuration of the imaging processing device 101 and the imaging device 102 according to the first embodiment.

The image processing device 101 includes a calculation unit 201, a storage unit 202, a display unit 203, a communication unit 204, and an input unit 205. The calculation unit 201 is any of various calculation devices such as a CPU or a GPU serving as a computer, performs a calculation process on an input signal in accordance with a computer program stored in the storage unit 202 or the like, and performs control on each unit included in the image processing device 101.

The storage unit 202 is a primary storage device or a secondary storage device such as a hard disk or a RAM and stores a computer program or the like regulating the CPU. The storage unit 202 serves as a working memory while a program is executed or is used to store a generated model, images, and various parameters. The display unit 203 is, for example, a display such as an LCD and displays various kinds of information for a user on a GUI.

The input unit 205 accepts various inputs from a user operating various input devices such as a mouse, a keyboard, and a touch panel on a display. In the embodiment, for example, a matching process with a model is performed in response to a request from the robot 105. Of course, a matching process may be performed by accepting a user input with the input unit 205. The communication unit 204 is any of various communication devices such as a network adaptor and performs communication with the robot 105, an external device, or the imaging device 102.

The imaging device 102 is connected to the image processing device 101 via, for example, a local area network (LAN), accepts an imaging command from the imaging processing device 101, and transmits a captured image. Of course, the communication unit is not limited to a LAN, and a USB or another communication protocol may be used. As the imaging device 102, a general industrial camera, a network camera, a single-lens camera, a compact digital camera, a web camera, a smartphone or a tablet terminal with a camera, or the like can also be used.

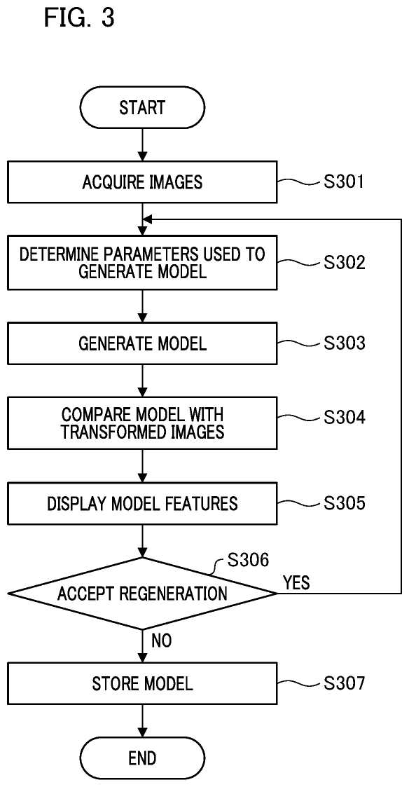

FIG. 3 is a flowchart illustrating an operation of the image processing device 101 when a matching model is generated according to the first embodiment. When the manufacturing system illustrated in FIG. 1 is installed, the image processing device 101 first generates a model and sets matching parameters. A flow of generation of the matching model will be described with reference to FIG. 3. The flow of FIG. 3 is implemented by allowing the image processing device 101 to execute a computer program stored in the storage unit 202 or the like. When the flow of FIG. 3 starts, it is assumed that the image processing device 101 is already in a model generation mode according to a user manipulation from the input unit 205.

First, in step S301, the image processing device 101 acquires model images used to generate the matching model. In the embodiment, the user installs the works 103 serving as a reference on the conveyance stand 104 and images the works with the imaging device 102 serving as an image acquisition unit connected to the image processing device 101 to acquire model image used to generate a model.

At this time, the images captured by the imaging device 102 are displayed as a live-view video on the display unit 203 and a model image acquisition button is displayed on a GUI screen of the display unit 203. The user can acquire a desired model image in the live-view video by clicking the model image acquisition button. The image acquisition unit (an image acquisition step) is not limited to a unit (step) that acquires images from an imaging device and may be a unit (step) of acquiring images from, for example, a storage medium. That is, images already stored in the storage medium or images subjected to various kinds of image processing such as monochrome processing or edge extraction may be read from the storage medium to acquire the images.

In step S302, the image processing device 101 determines various parameters used to generate the matching model. The various parameters include, for example, parameters used to generate the matching model such as a region setting parameter used to set a model generation region from an image, a parameter related to a luminance gradient or an edge, and parameters related to various matching schemes in which feature points are bases. In the embodiment, a region of the works 103 which are in the model image is set and feature amount extraction of an edge base is performed to generate the matching model. Therefore, the user can input parameters used to generate the matching model using a GUI screen of the display unit 203.

In step S303, the image processing device 101 generates the matching model based on the model images acquired in step S301 and the model generation parameters determined in step S302. Here, step S302 functions as a matching model acquisition unit (a matching model acquisition step) acquiring the image processing matching model based on the images acquired by the image acquisition unit. The matching model acquisition unit may be a self-unit generating the matching model as in step S303 or may be a unit acquiring a generated matching model from the outside, an internal storage unit, or the like.

In the embodiment, the matching model is a model in which edge-based feature amounts in the region set in step S302 are extracted. When an allowable value for rotation or extraction/contraction is set in advance as the model generation parameter, a plurality of matching models changed in advance to accelerate the matching process may be generated.

In step S304, the image processing device 101 transforms the model images used to generate the matching model. Here, step S304 functions as an image transformation unit (image transformation step) acquiring transformed images obtained by performing predetermined transformation on the images. Step S304 also functions as a comparison unit (comparison step) comparing the matching model acquired by the matching model acquisition unit with the transformed images. The transformation performed by the image transformation unit includes at least one of rotational transformation, expansion/contraction transformation, affine transformation, projective transformation such as tilt changing, nonlinear transformation such as barreled distortion correction on an imaging surface in accordance with camera lens features or the like, brightness transformation, hue transformation, and noise level transformation of a model image.

The foregoing image transformation may be a classical rule-based transformation scheme or transformation using a learned model such as convolutional neural network (CNN) may be used.

In addition, the image processing device 101 compares the transformed images with the matching model generated in step S303.

In this way, by generating the transformed images based on the model images used to generate the matching model and comparing the transformed images with the matching model, it is possible to simulate and estimate the degree of influence of similarity on the transformation.

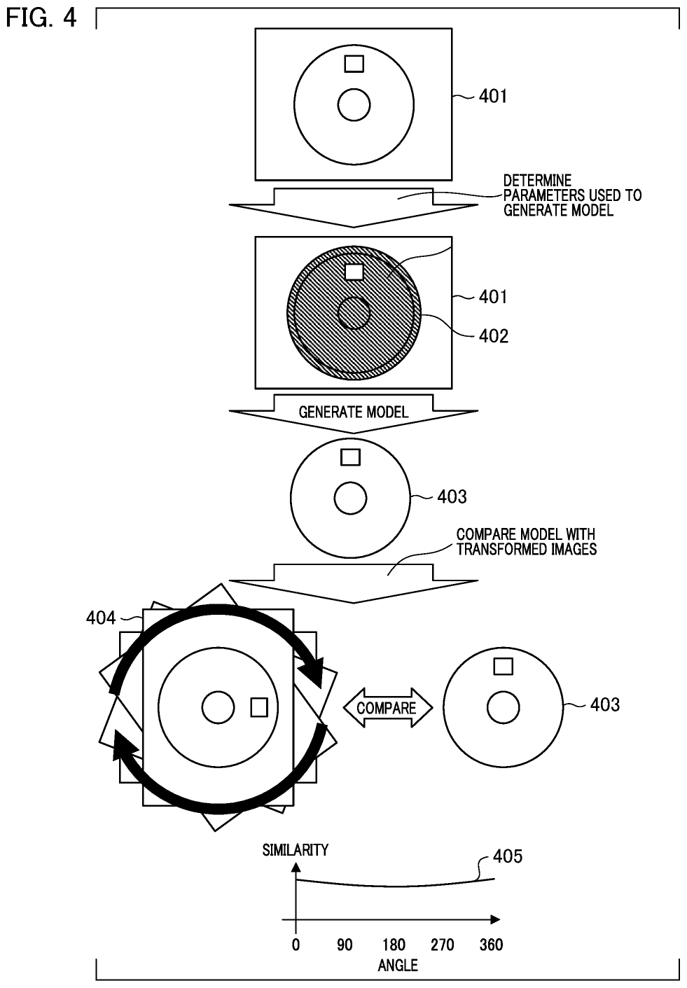

FIG. 4 is a diagram illustrating a method of estimating a change in similarity related to a change in rotation according to the first embodiment.

When a model generation region shown in a model generation region 402 is set in a model image 401 of the works 103 disposed at a reference position and a matching model 403 is generated, for example, a plurality of transformed images 404 are generated by performing rotational transformation on the model image 401. By performing the matching between the plurality of transformed images 404 and the matching model 403, it is possible to estimate and display a change 405 in similarity to a change in rotation as in a graph of FIG. 4.

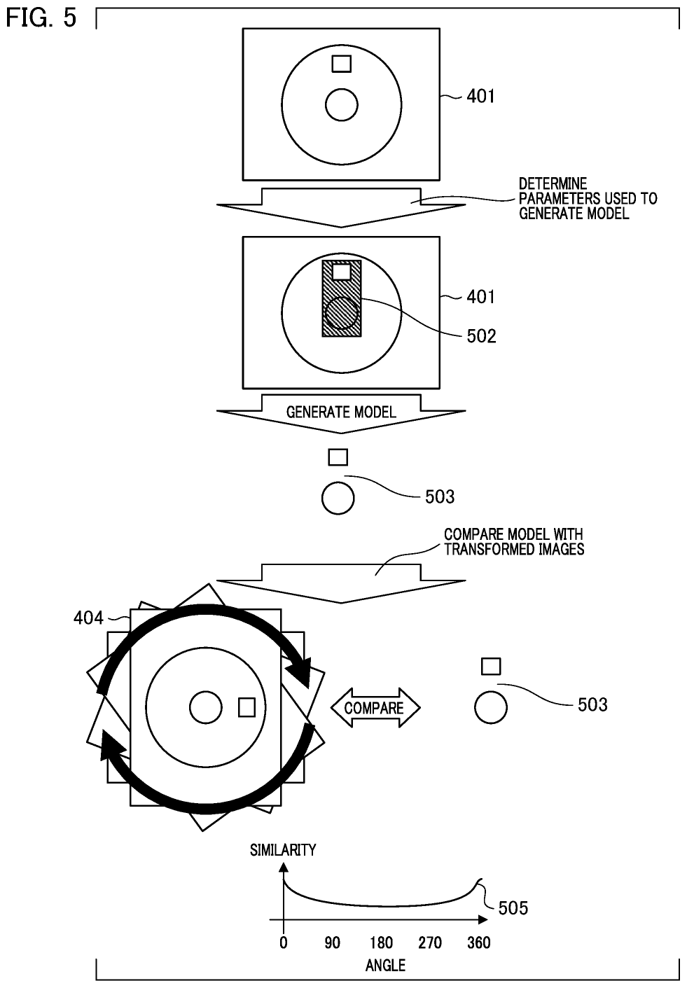

FIG. 5 is a diagram illustrating a change in the similarity related to the change in rotation when model generation parameters are different according to the first embodiment.

A matching model 503 is generated by setting a model generation region such as a model generation region 502 of FIG. 5 in the model image 401. In this case, by performing matching between the plurality of transformed images 404 with different rotational phases and the matching model 503, it is possible to simulate and estimate a change 505 in similarity to a change in rotation as in the graph of FIG. 5.

Compared to the matching model 403, the matching model 503 has no rotational symmetry. Accordingly, in the change 505 in similarity to the change in rotation, a ratio of a change similarity to the change in the rotation is larger than in the change 405 in similarity to the change in rotation. When a change other than the change in rotation is performed, it is also possible to simulate and estimate the degree of influence in accordance with the same scheme.

In step S305, the image processing device 101 estimates features of the matching model based on the degree of influence of similarity estimated in step S304 and presents the features on a GUI of the display unit 203 to the user. Here, step S305 functions as a display unit (display step) displaying support information to optimize the matching model based on a result of the comparison unit. The support information includes, for example, feature information regarding the matching model. The feature information includes, for example, information regarding the matching model, the transformed images, and similarity.

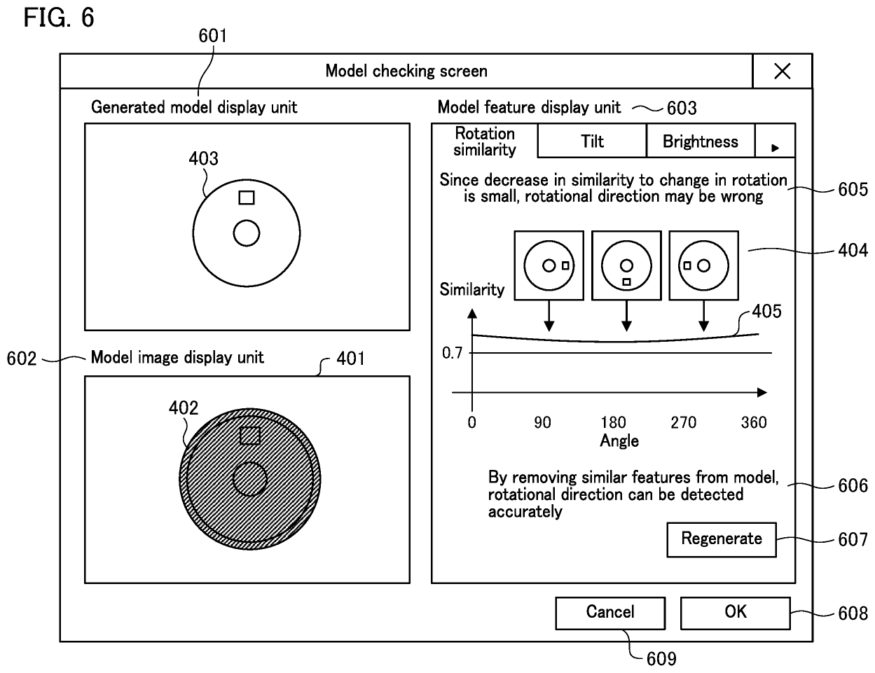

FIG. 6 is a diagram illustrating a GUI on which model features are displayed according to the first embodiment. For example, by displaying the GUI illustrated in FIG. 6, it is possible to check whether the generated matching model has features desired by the user with respect to various changes. Accordingly, it is possible to support optimization of the matching model. Here, the model image 401, the model generation region 402, the matching model 403, the plurality of transformed images 404, and the change 405 in similarly with respect to the change in rotation, as illustrated in FIG. 4, will be described as examples.

A generated model display unit 601 is a portion in which information regarding the generated matching model is displayed. When an edge of the matching model 403 is visualized and displayed, the user can check the form of the generated matching model. At this time, detailed information may be provided by displaying not only an image but also metadata subsidiary to the matching model 403.

For example, when a hierarchical model structure is given for calculation efficiency in searching of the matching model 403 or a model table for expansion/contraction or the change in rotation is given, metadata or the like related thereto is displayed. A GUI on which hierarchy of the matching model 403 or an expansion/contraction amount or a rotation amount can be designated may be added to the generated model display unit 601 so that a form of the matching model can be displayed in a selected hierarchy or at the expansion/contraction amount or the rotation amount.

The model image display unit 602 is a portion in which information regarding a model image which is a basis for generating the matching model is displayed. When the model image 401 is displayed in the model image display unit 602, the user can compare the matching model 403 with the model image 401 and check whether the matching model 403 intended by the user can be generated from the model image 401.

At this time, important parameters set to generate the model such as the model generation region 402 may be displayed in the model image display unit 602. Thus, the user can check whether the matching model intended by the user can be generated while checking the model generation parameters set by the user, and thus the optimization of the matching model can be supported.

A model feature display unit 603 is a portion in which features or the like of the matching model are displayed as support information for optimizing the matching model. For example, when the change 405 in similarity to the change in rotation is displayed in a graph or the like, the user can visually check features of the matching model. At this time, the important transformed images 404 indicating that the similarity is greater or less than a predetermined value may be displayed in association with the graph.

Thus, the user can visually check how the similarity of the matching model is changed with respect to a transformed image. The change 405 in similarity may be analyzed by AI and explanation of the features of the matching model may be performed in an explanation unit 605 of the features in an expression that the user can easily understand. For example, when there are many rotational symmetric elements in the matching model, there are change amounts at which a decrease in the similarity to the change in rotation is small or the similarity increases.

In this case, the matching model can display support information indicating that there is a possibility of accurate matching to the change in rotation not being able to be performed. When there are likely to be features which are not desired by the user, as shown in a suggestion unit 606 in FIG. 6, suggestion of the regeneration of the matching model and advice for supporting the regeneration may be presented as support information for optimizing the matching model.

At this time, based on the information input by the user in step S302, the user's intention or the like to generate the model may be estimated based on the model generation parameters or the like and content of the advice may be changed. For example, when a rotational table is designated as a model generation parameter in the generation of the matching model in step S302, it is estimated that the user is highly likely to desire to acquire information regarding the change in the rotation of the works. Accordingly, when there is a state in which the similarity to the change in the rotation is high, the advice may be displayed more emphatically.

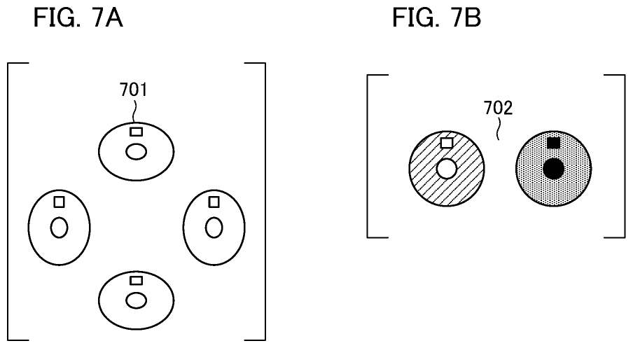

Of course, when an influence involved in a change other than the change in the rotation is similarly displayed, the user can easily check the model features. For example, FIG. 7A is a diagram illustrating a method of displaying model features related to a change in tilt and brightness according to the first embodiment. In a case in which model features of a change in tilt are displayed, the model features may be indicated by exemplifying a plurality of transformed images in reference numeral 701 when the change in tilt is performed.

For brightness, model features may be indicated by exemplifying a plurality of transformed images in reference numeral 702 of FIG. 7B in a case in which a change in brightness is performed. As the exemplified images at this time, for example, transformed images with a change amount of any similarity may be exemplified. Any similarity may be a default value of the system or may be determined through a user input.

In this way, when the changed images in a matchable range are displayed, the user can visually check a relation between the model generation parameter and a change in similarity or the like. In this way, in the embodiment, the display unit displays the matching model, the images, and the support information in the same screen. Therefore, a job in which the user optimizes the matching model can be made efficient.

In step S306, the image processing device 101 accepts a user input from the input unit 205 on, for example, the GUI illustrated in FIG. 6 with regard to a result of feature checking of the model. When the fact that there is no problem in the model features is input (an “OK” button 608 in FIG. 6 is clicked), it is determined that the regeneration is not performed and the process transitions to step S307. On the other hand, when a “Cancel” button 609 is clicked, the flow of FIG. 6 ends. When the fact that the regeneration is performed is input (a “Regenerate” button 607 in FIG. 6 is clicked), the process returns to step S302.

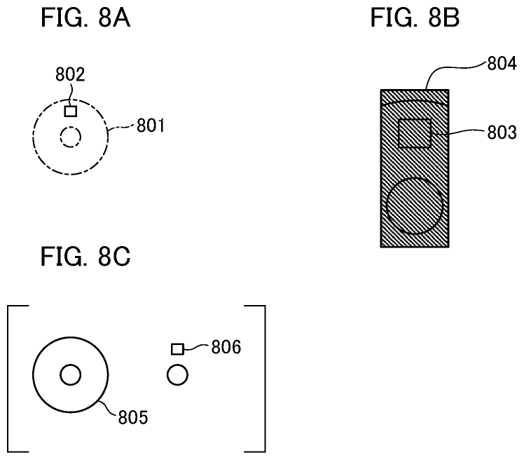

At this time, a GUI for supporting the model regeneration of the user may be displayed. FIG. 8A is a diagram illustrating an example of a GUI when the regeneration is supported according to the first embodiment.

For example, the model regeneration of the user may be supported by separately displaying a feature 802 in which a change in similarity is large and a feature 801 in which a change in similarity is small in different display formats with respect to a feature of a change (for example, a change in rotation) of which reproduction is desired by the user. Therefore, for example, by dividing a matching model region arbitrarily, comparing the transformed images in the divided regions, and estimating features, it is possible to classify features in which the change in similarity is large and features in which the change in similarity is small.

The model regeneration may be supported by displaying a recommended model 803 or a recommended model generation region 804 as in FIG. 8B or displaying recommended model generation parameters based on a result of the classification. A primary searching matching model 805 and a matching model 806 for determining a secondary searching angle to perform detailed searching from a region found through first searching and obtain a matching result may be individually displayed based on the classified features, as in FIG. 8C.

The model reproduction of the user may be supported by recommending the user to separately perform first searching in which the matching model 805 is used and second searching in which the matching model 806 is used. According to such advice, the user can select or determine the parameters in the regeneration more easily and accurately. The GUI in FIGS. 8A to 8C may be displayed in the suggestion unit 606 or may be displayed in a separate window in the regeneration.

The model regeneration may be supported by simultaneously displaying the matching model before the regeneration or the matching model after the regeneration in separate windows or the same window with dotted lines. Thus, the user can check the model features while performing comparison with a previous matching model. This is useful when the reproduction is performed several times.

In this way, by suggesting the model features while comparing the model features, it can be easy to simulate and check whether the model has desired features, and thus it is not necessary for the user to perform trial-and-error several times during actual manufacturing. Accordingly, in a manufacturing system or the like, it is possible to considerably shorten work steps of adjusting the image processing system.

### Second Embodiment

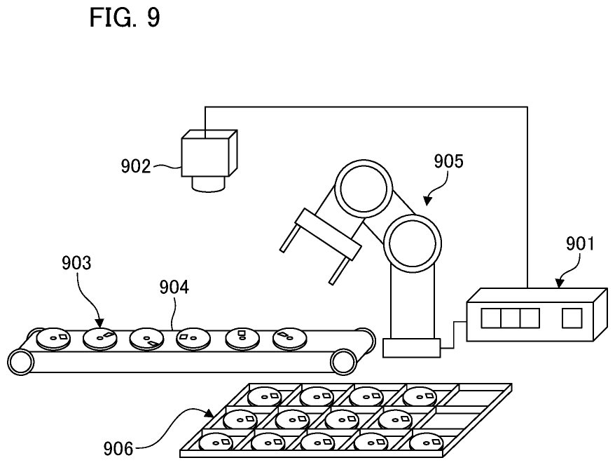

Next, a second embodiment of the present invention will be described with reference to FIGS. 9 to 15.

A manufacturing system according to the second embodiment is assumed to be duplicated from the manufacturing system described in the first embodiment. A method of determining model generation parameters in the duplication will be described.

FIG. 9 is a diagram illustrating an overview of a manufacturing system according to the second embodiment and illustrates a system obtained by duplicating the manufacturing system in FIG. 1. Accordingly, reference numerals 901 to 906 in FIG. 9 indicate the configurations indicated by reference numerals 101 to 106 in FIG. 1. An image processing device 901 has the same configuration as the image processing device 101. The storage unit 202 in the image processing device 901 according to the second embodiment is assumed to store the generated matching model optimized through the regeneration based on the flowchart of FIG. 3 in the image processing device 101. The model generation parameters in the generation of the matching model are also assumed to be stored in association with the matching model (as a set).

A location at which the matching model generated by the image processing device 101 and the model generation parameters are stored is not limited to the storage unit 202 in the image processing device 901 and may be a storage medium which can be accessed by the image processing device 901. Another information may be stored along with the generated matching model and the parameters in the generation of the matching model. For example, detection parameters or the like used for the image processing device 101 to perform a matching process previously may be stored incidentally.

The model generation parameters in the second embodiment are assumed to include information regarding the model generation region in the following description. As in the first embodiment, constituent elements in the second embodiment are merely exemplary and the present invention is not limited thereto.

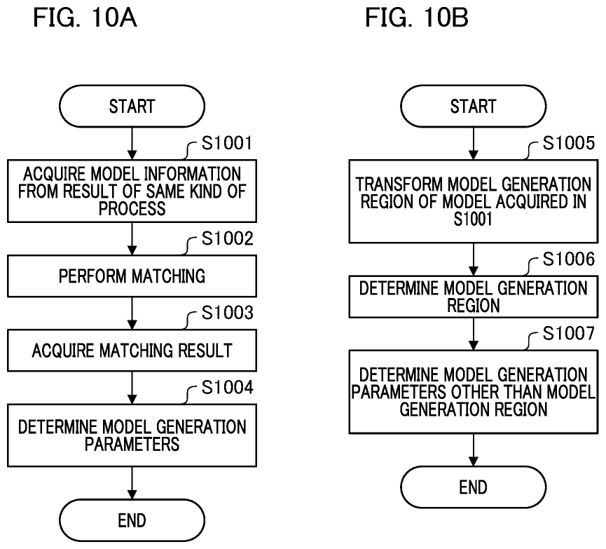

FIGS. 10A and 10B are flowcharts related to model generation according to the second embodiment and implemented by causing a computer in the image processing device 901 to execute a computer program stored in the storage unit 202 or the like. FIG. 10A is a flowchart illustrating generation of the model generation parameters. A basic model generation flow in the second embodiment is the same as the flow illustrated in the flowchart of FIG. 3. In the second embodiment, however, the process of determining the model generation parameters in step S302 of FIG. 3 is substituted with processes in FIGS. 10A and 10B.

In step S1001, the image processing device 901 acquires a set of a generated matching model stored in the storage unit 202 in the image processing device 901 and model generation parameters in the generation of the matching model stored in association with the matching model. The generated matching model and the model generation parameters in the generation of the matching model may be the matching model and the model generation parameters generated when the manufacturing system described in the first embodiment start up.

A matching model generated in another manufacturing system desired to be duplicated and model generation parameters may be used. The set of the matching model and the parameters may be acquired from an external device such as a network server instead of acquiring the matching model and the parameters from the internal storage unit 202. Alternatively, the set of the matching model and the parameters may be generated in the other image processing device 101 or may be generated in the image processing device 901.

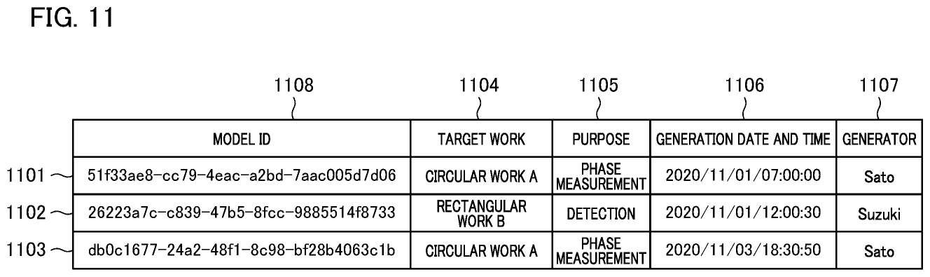

FIG. 11 is a diagram illustrating an example of a list of stored model generation parameters according to the second embodiment. Various kinds of metadata such as a target work (kind of target work) 1104, a purpose 1105, a generation date and time 1106, and a generator 1107 are associated with each of matching models 1101 to 1103 by a model ID 1108 and are stored as a set.

The metadata is not limited to the foregoing parameters and a model image or another information characterizing the matching model may be added. The matching model or the model generation parameters may be able to be stored in the storage unit 202 automatically when the matching model is generated or may be stored at any timing by the user.

When a matching model or model generation parameters appropriate to determine a model generation region are selected from a plurality of stored matching models or model generation parameters, the image processing device 901 may automatically select the matching model and the model generation parameters based on metadata or the like of the matching model. Alternatively, a list illustrated in FIG. 11 may be displayed on a GUI and the matching model and the model generation parameters may be selected through a user input. That is, the display unit may display all the matching model and the parameters associated with the matching model.

At this time, the set of the matching model and the parameters associated with the matching model differs in accordance with a target (a work or the like) included in the image.

For example, when the image processing device 901 measures a work 903 in the second embodiment and the kind of work 903 is a circular work A, matching models 1101 and 1103 become selection candidates.

At this time, a matching model of which a generation date and time is newer may be selected or any matching model may be selected in consideration of the generator or other information. In the second embodiment, the matching model 1101 is assumed to be selected in the following description.

When the foregoing existing matching model is a matching model generated after a detailed region is restricted, it is very difficult to regenerate the same model in the related art. This is because a feature region desired to be modeled cannot be said to be normally extracted in accordance with a simple method. Manual restriction of the detailed region is a time-consuming job although the region is manually restricted. Therefore, much time may be consumed in this job constantly.

In the embodiment, however, since information regarding the matching model generated in the manufacturing system (image processing system) desired to be duplicated or the model generation parameters is acquired as in step S1001, it is possible to considerably reduce a time taken to regenerate the model. In particular, a job step of building a region in which time is taken despite an expert can be considerably shortened and a model adjusted by an expert can be easily used by even a beginner.

In step S1002, the image processing device 901 performs matching between the matching model acquired in step S1001 and the model images of the works or the like serving as targets acquired in a step similar to step S301 of FIG. 3. Here, step S1002 functions as an image processing unit performing a matching process between the matching model acquired in the matching model acquisition unit and a target included in the image.

When the matching is performed, a detection parameter can be set. The detection parameter is, for example, a detection threshold of similarity of a searching region or a detection threshold of a phase. When the detection parameter is recorded in the information acquired in step S1001, the detection parameter may be used as it is or a value lowered by deduction of a given value or multiplication of a given ratio may be used to obtain more detection results.

When the detection parameter is not recorded in the information acquired in step S1001, the detection parameter may be determined based on a setting maximum value of the detection threshold or a default value of the system.

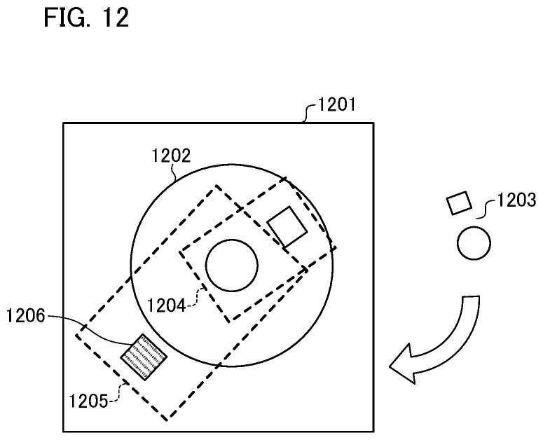

FIG. 12 is a diagram illustrating an example of searching of a similar region by the matching according to the second embodiment and illustrates an example of searching of a similar region by the matching. Similar regions are searched using a generated matching model 1203 acquired in step S1001 with regard to a model image 1201 to find, for example, regions appropriate for the model generation of a work 1202.

In FIG. 12, similar regions 1204 and 1205 are illustrated as a searching result. For the similar region 1205, a circular region of the work and noise 1206 are erroneously determined and matched. As the noise 1206, an accidentally captured component or the like of a device or a part or the like of a background is assumed.

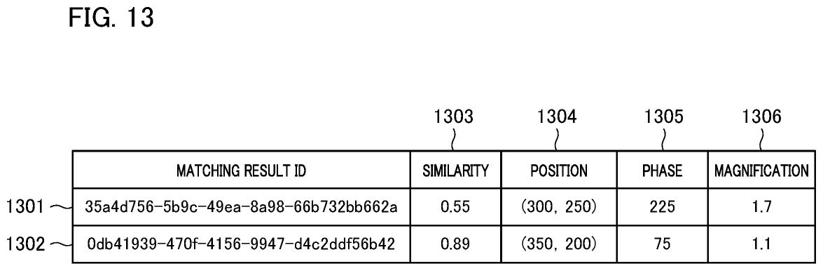

In step S1003, the image processing device 901 acquires a result of the matching process performed in step S1002 and the display unit 203 displays the result of the matching process by the image processing unit, for example, as in FIG. 13.

FIG. 13 is a diagram illustrating a result of the searching illustrated in FIG. 12. The display unit displays similarity or the like of a target (a work or the like) matching the matching model as the result of the matching process. A searching result 1301 corresponds to the similar region 1205 and a searching result 1302 corresponds to the similar region 1204. From the searching results, detection information such as similarity 1303, a position 1304, a phase 1305, and magnification 1306 can be acquired.

That is, the display unit displays at least one of a position, a phase, and magnification of a matched target (work or the like) as a result of the matching result.

Further, when a searching result appropriate for the model generation region is acquired from the plurality of searching results, the image processing device 901 may automatically select the searching result based on the detection information or may display the list illustrated in FIG. 13 on a GUI and the searching result may be selected through a user input.

In the automatic selection based on the detection information, the searching result in which the similarity is the highest may be selected and the searching result may be selected by comparing a weighted addition value with respect to the other detection information with a predetermined threshold. In the case of the selection through the user input, for example, a threshold may be provided in advance for each value of the detection information and a searching result may be selected from the detection results corresponding to this range, and the detection result may be narrowed down. In the second embodiment, the searching result 1302 in which the similarity is the highest is assumed to be automatically selected by the image processing device 901 in the following description.

In step S1004, the image processing device 901 determines the model generation parameters based on the searching result acquired in step S1003. FIG. 10B illustrates the detailed flow of step S1004.

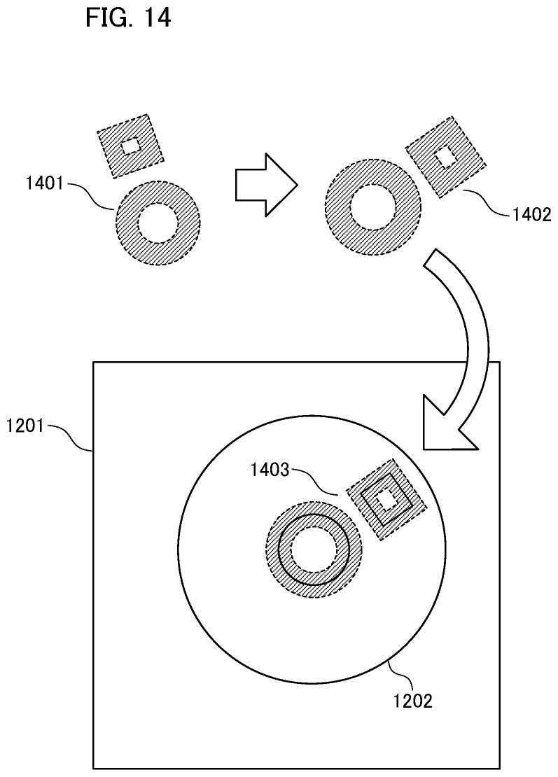

In step S1005, the image processing device 901 transforms the model regeneration region of the matching model 1203 included in the model generation parameters acquired in step S1001 based on the detection information acquired in step S1003. FIG. 14 is a diagram illustrating an example of transformation of a region based on detection information according to the second embodiment.

For the model generation region 1401 of the matching model 1203 acquired in step S1001, a phase is rotated by 75 degrees and magnification is expanded to 1.1 based on the phase 1305 and the magnification 1306 from the detection information of the searching result 1302 by the matching. Therefore, the model generation region is transformed using affine transformation and an interpolation process or the like associated with the affine transformation to generate a transformed region 1402.

In step S1006, the image processing device 901 determines a model generation region of the model image 1201 using the transformed region 1402. Referring to reference to the position 1304 from the detection information of the searching result 1302 by the matching, the transformed region 1402 is disposed at a position (350, 200) of the model image 1201 and is set as a model generation region 1403 of the model image 1201. After the model generation region 1403 is generated, the model generation region 1403 may also be able to be adjusted through a user input. In this way, the user can easily determine the optimum model generation region 1403 without performing a troublesome manipulation. Therefore, it is possible to shorten the job step for the duplication considerably compared to a known method generated from the beginning.

In step S1007, the image processing device 901 determines model generation parameters other than the model generation region. The second embodiment is an example of the mode generation based on shape information. Therefore, determination of a contrast threshold which is a parameter for extracting shape information will be described as an example. In the second embodiment, by adjusting the contrast threshold so that shape information identical to that of the matching model acquired in step S1001 is included, a matching model in which measurement identical to that of the matching model can be expected is generated.

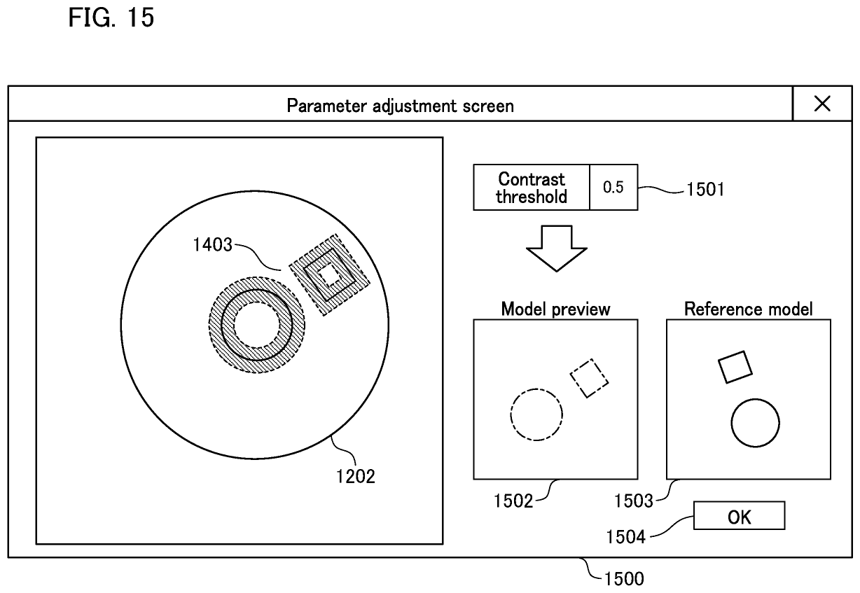

FIG. 15 is a diagram illustrating an example of a GUI for setting a contrast threshold. In accordance with a value of the contrast threshold 1501, shape information regarding the work 1202 designated in the model generation region 1403 is extracted and an extraction result is displayed a model preview region 1502 of the parameter adjustment screen 1500. That is, the display unit can display the contrast threshold as a parameter adjustably.

When the user performs the adjustment with reference to the model displayed in the reference model region 1503 and acquired in step S1001 and determines that a desired shape can be extracted, the user can click a button 1504 to determine the contrast threshold. The shape information is a collection of dot groups. Therefore, for example, the contrast threshold may be adjusted automatically so that total numbers of the dot groups are equal. In this case, the model acquired in step S1001 is subjected to expansion/contraction transformation similar to that in the generation of the transformed region 1402, and then the total numbers of dot groups are compared, and the contrast threshold is determined so that a comparison result is within a preset threshold.

The adjustment method in which the matching model acquired in step S1001 is compared has been described above, but the parameter adjustment may be performed using another unit which does not perform the comparison. The contrast threshold has been described as an example of the model generation parameter in the second embodiment, but may be applied to, for example, parameter adjustment or the like of filter processing performed in preprocessing of feature extraction.

When the model generation parameter is determined, as described above, the user can determine the parameter while reducing a generation time of the model generation region in duplication or the like of the system. Further, since a known matching model or model generation parameters can be used, it is possible to duplicate the matching model with measurement accuracy identical to measurement accuracy of a known matching model generated by taking time in a short time.

The building of the model in which the measurement accuracy is high depends on an expert, but this can be used by an inexperienced person or a beginner without difficulty. Further, since a GUI manipulation such as adjustment of a region can be reduced as much as possible, the job step can be shortened despite a model in which complicated building is performed.

In the second embodiment, the example of the matching process or the like in the case of the duplication of the manufacturing system (the image processing system) has been described. However, for example, in the manufacturing system (the image processing system) according to the first embodiment, it is needless to say that the matching process described in the FIGS. 10 to 15 or the subsequent model generation parameter processing may be performed. In this case, it is possible to easily correct an error or the like caused due to a change over time in the same manufacturing system (the image processing system).

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions. In addition, as a part or the whole of the control according to this embodiment, a computer program realizing the function of the embodiment described above may be supplied to the image processing device through a network or various storage media. Then, a computer (or a CPU, an MPU, or the like) of the image processing device may be configured to read and execute the program. In such a case, the program and the storage medium storing the program configure the present invention.

This application claims the benefit of Japanese Patent Application No. 2021-018241 filed on Feb. 8, 2021, which is hereby incorporated by reference herein in its entirety.

What is claimed is:

1. An image processing device comprising at least one processor and/or circuit configured to function as:
an image acquisition unit;
a matching model acquisition unit configured to acquire an image processing matching model based on an image acquired by the image acquisition unit;
an image transformation unit configured to perform predetermined transformation on the image to acquire a transformed image;
a comparison unit configured to compare the matching model acquired by the matching model acquisition unit with the transformed image acquired by the image transformation unit; and
a display unit configured to display support information for optimizing the matching model based on a result of the comparison unit.

2. The image processing device according to claim 1, wherein the image transformation unit performs at least one transformation on the image among rotational transformation, expansion/contraction transformation, affine transformation, projective transformation, nonlinear transformation, brightness transformation, hue transformation, and noise level transformation.

3. The image processing device according to claim 1, wherein the support information includes feature information of the matching model.

4. The image processing device according to claim 3, wherein the feature information includes information regarding similarity between the matching model and the transformed image.

5. The image processing device according to claim 1, wherein the display unit displays similarity between the matching model and a plurality of the transformed images in a graph.

6. The image processing device according to claim 1, wherein the display unit displays the matching model, the image, and the support information on the same screen.

7. The image processing device according to claim 1, wherein the support information includes advice for a user.

8. The image processing device according to claim 1, wherein the support information includes information for regenerating the matching model.

9. The image processing device according to claim 8, wherein the display unit simultaneously displays the matching model before the regeneration and the matching model after the regeneration as the support information.

10. The image processing device according to claim 1, wherein the image acquisition unit acquires the image from the imaging unit or the storage medium.

11. The image processing device according to claim 1, wherein the matching model acquisition unit acquires a set of the matching model and parameters used to generate the matching model.

12. The image processing device according to claim 11, wherein the display unit displays both the matching model and the parameters.

13. The image processing device according to claim 11, wherein the matching model acquisition unit acquires the set of the matching model and the parameters from an external device.

14. The image processing device according to claim 11, wherein the set of the matching model and the parameters is different in accordance with a target included in the image.

15. The image processing device according to claim 11, wherein the set of the matching model and the parameters is generated in another image processing device.

16. The image processing device according to claim 1, further comprising:
an image processing unit configured to perform a matching process between the matching model acquired by the matching model acquisition unit and a target included in the image,
wherein the display unit displays a result of the matching process by the image processing unit.

17. The image processing device according to claim 16, wherein the display unit displays similarity between the matching model and the matched target as a result of the matching process.

18. The image processing device according to claim 17, wherein the display unit displays at least one of a position, a phase, and magnification of the matched target as the result of the matching process.

19. The image processing device according to claim 12, wherein the display unit displays a contrast threshold as the parameter adjustably.

20. A non-transitory computer-readable storage medium configured to store a computer program to execute the following steps:
an image acquisition step;
a matching model acquisition step of acquiring an image processing matching model based on an image acquired in the image acquisition step;
an image transformation step of performing predetermined transformation on the image to acquire a transformed image;
a comparison step of comparing the matching model acquired in the matching model acquisition step with the transformed image acquired in the image transformation step; and
a display step of displaying support information for optimizing the matching model based on a result of the comparison step.

21. An image processing method comprising:
an image acquisition step;
a matching model acquisition step of acquiring an image processing matching model based on an image acquired in the image acquisition step;
an image transformation step of performing predetermined transformation on the image to acquire a transformed image;
a comparison step of comparing the matching model acquired in the matching model acquisition step with the transformed image acquired in the image transformation step; and
a display step of displaying support information for optimizing the matching model based on a result of the comparison step.
